(19) United States
(12) Patent Application Publication
(10) Pub. No.: US 2017/0017343 A1
(43) Pub. Date: Jan. 19, 2017

(54) Noise reduction capacitive touch control panel

(71) Applicant: Inputek Co. Ltd., Hsinchu County (TW)

(72) Inventors: Chi Chin CHEN, Hsinchu County (TW); Wen Yi LEE, Hsinchu County (TW); Chia Wei WU, Hsinchu County (TW); Chang Kuang CHUNG, Hsinchu County (TW); Tse Yen LIN, Hsinchu County (TW)

(21) Appl. No.: 14/802,640

(22) Filed: Jul. 17, 2015

(51) Int. Cl. G06F 3/041; G06F 3/044

(52) U.S. Cl. CPC G06F 3/0418; G06F 3/044; G06F 3/0412

(57) ABSTRACT

A noise reduction capacitive touch panel comprises a sensing area, a non-sensing area, a main body, a plurality of driving electrodes, a plurality of driving electrode wires, a plurality of sensing electrodes, a plurality of sensing electrode wires, at least one noise sensing electrodes and at least noise sensing electrode wires. The sensing area is located in the middle of the panel and the rest area of the panel is the non-sensing area. The main body is a flat board having a normal line. The driving electrodes are strip electrodes and disposed on the main body. The driving electrodes are perpendicular to the normal line. The driving electrodes wires are disposed on the main body. The sensing electrodes are strip electrodes and disposed on the main body. Capacitive coupling is occurred between the driving electrodes and the sensing electrodes because there is a distance between them.

### FIELD OF THE INVENTION

The present invention relates to capacitive touch panel. More specifically, it is a capacitive touch panel, which is able to reduce noise.

### BACKGROUND OF THE INVENTION

The touch screen technology has been used in a wide variety of different areas and applications, such as mobile phone, tablet computer, game console, and screens of many other devices. A touch screen is an electronic visual display that the user can control through simple or multi-touch gestures by touching the screen with one or more fingers. Some touch screens can also detect objects such as a stylus or ordinary or specially coated gloves. The touch screen technology is very popular because it enables the user to interact directly with what is displayed, rather than using a mouse, touchpad, or any other intermediate device.

Generally, touch control panels comprises a substrate, an electrode layer disposed on the substrate, and a display below the substrate. When a finger contacts with a touch panel, the finger and the electrodes form a temporary capacitor. The finger distorts the local electrostatic field at that point. This is measurable as a change in capacitance. The temporary capacitor will bring the environmental noise and the 60 Hz noise into the control signal of the touch control panel. Besides, the driving voltage of the display, like liquid crystal display (LCD), will disturb the control signal through the electrodes. The environmental noise, the 60 Hz noise, and the LCD driving voltage noise will make the touch panel detect a wrong touch position or unreal signal. In this case, noise reduction is one of the most important functions in a touch control panel.

In generally, the noise signal is reduced by software computation or circuit computation, however, those methods either will take a long time or have limited capacity of reducing the noises. Another method is to add an electrode in the sensing area, which located in the middle of the substrate to sense the noise signal and the noise can be subtracted. However, the added electrode can also sense the touch signal; therefore, the useful touch signal is reduced as well. The method of efficiently reducing environmental noise, the 60 Hz noise, and the LCD noise and keeping the strength of the touch signal is needed.

### BRIEF DESCRIPTION OF THE DRAWINGS

FIG. 1 is a exploded view of the first preferred embodiment.

FIG. 2 is a top view of the first preferred embodiment.

FIG. 3 is a cross sectional view of the present invention taken along line 3-3 of FIG. 2.

FIG. 4 is a cross sectional view of the second preferred embodiment.

FIG. 5 is a top view of the third preferred embodiment.

FIG. 6 is a cross sectional view of the present invention taken along line 6-6 of FIG. 5.

FIG. 7 is a cross sectional view of the present invention taken along line 7-7 of FIG. 5.

FIG. 8 is a top view of the fourth preferred embodiment.

### DETAILED DESCRIPTION OF THE INVENTION

All illustrations of the drawings and description of the four preferred embodiments are for the purpose of describing selected versions of the present invention and are not intended to limit the scope of the present invention.

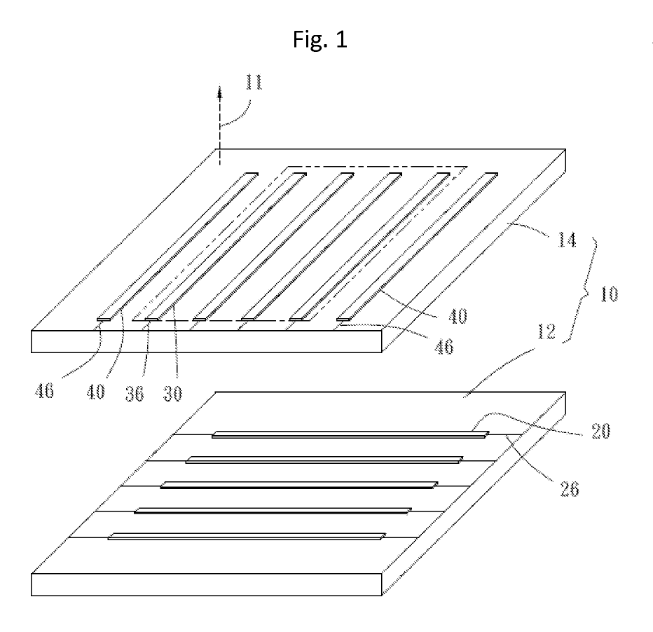

FIG. 1 to FIG. 3 illustrates the noise reduction capacitive touch panel of the first preferred embodiment. As shown in FIG. 1, the first preferred embodiment comprises a sensing area 70, a non-sensing area 72, a main body 10, a plurality of driving electrodes 20, a plurality of driving electrode wires 26, a plurality of sensing electrodes 30, a plurality of sensing electrode wires 36, two noise sensing electrodes 40 and two noise sensing electrode wires 46. The sensing area 70 is located in the middle of the panel and the rest area of the panel is the non-sensing area 72, which surrounds the sensing area 70. The main body 10 is a flat board has a normal line 11, a top board 14, and a bottom board 12. The bottom board 12 is located below the top board 14. The main body 10 is made of transparent materials like glass, polymer materials, or acrylic et al.

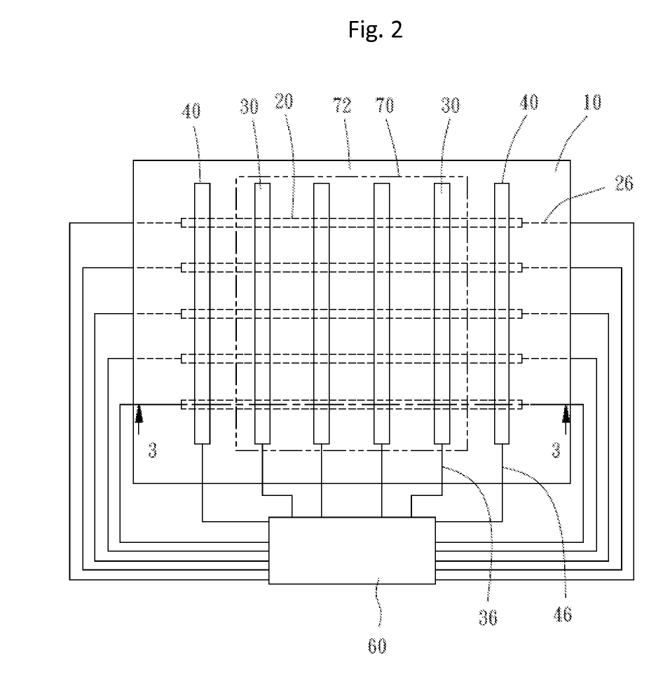

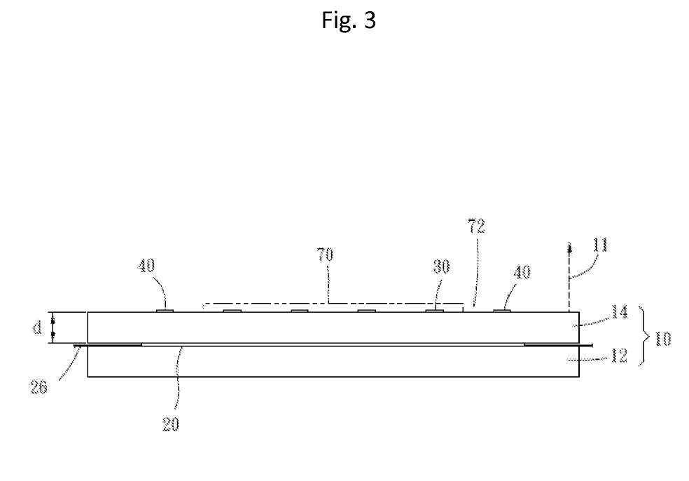

The driving electrodes 20 are strip electrodes and disposed on the top surface of the bottom board 12. The driving electrodes 20 are perpendicular to the normal line 11. The driving electrodes wires 26 are disposed on the top surface of the bottom board 12, each end of each driving electrode 20 electronically connected to one of the driving electrode wires 26. The sensing electrodes 30 are strip electrodes and disposed on the top surface of the top board 14. The sensing electrodes 30 are perpendicular to the normal line 11. As shown in FIG. 2, the extending direction of the sensing electrodes 30 is perpendicular to the extending direction of the driving electrodes 20. As shown in FIG. 3, distance between the driving electrodes 20 and the sensing electrodes 30 is the thickness d of the top board 14, in this case, capacitive coupling can be occurred between the driving electrodes 20 and the sensing electrodes 30. The intersection area of the driving electrodes 20 and the sensing electrodes 30 is covered by the sensing area 70. The sensing electrode wires 36 are disposed on the top surface of the top board 14, each sensing electrode 30 electronically connected to one of the sensing electrode wires 36.

As shown in FIG. 2, the noise sensing electrodes 40 are strip electrodes and disposed on the top surface of the top board 14. The noise sensing electrodes 40 are located in the non-sensing area 72, and the two noise sensing electrodes 40 are disposed on the left and right side of the sensing electrodes 30. The noise sensing electrodes 40 are perpendicular to the normal line 11. As shown in FIG. 3, distance between the driving electrodes 20 and the noise sensing electrodes 40 is the thickness d of the top board 14, in this case, capacitive coupling can be occurred between the driving electrodes 20 and the noise sensing electrodes 40. The two sensing electrode wires 46 are disposed on the top surface of the top board 14, e each noise sensing electrode 40 electronically connected to one of the noise sensing electrode wires 46.

Since the noise sensing electrodes 40 are located in the non-sensing area 72, the noise sensing electrodes 40 are able to sense the environmental noise and the 60 Hz noise, and won't sense the touch control signals when a finger touching the touch control panel. The noise sensing electrodes 40 are able to form capacitive coupling with the driving electrodes 20 located inside the sensing area 70, so the noise sensing electrodes 40 are able to sense the LCD noise as well.

By using the above mentioned touch control panel coordinate with the known computational method, the environmental noise, 60 Hz noise and the LCD driving voltage noise can be reduced efficiently while the strength of the touch control signal is maintained. The computational method is to use the signal received by the sensing electrodes 30 subtracts the signal received by the noise sensing electrodes 40.

In the first preferred embodiment, the touch control panel comprises a microcontroller unit 60. The microcontroller unit 60 electronically connects to the driving electrodes wires 26, the sensing electrode wires 36, and the noise sensing electrode wires 46. The microcontroller unit 60 sends driving signals to the driving electrodes 20 through the driving electrodes wires 26; receives sensing signals from the sensing electrodes 30 through the sensing electrode wires 36; and receives noise sensing signals from the noise sensing electrodes 40 through the noise sensing electrode wires 46. The microcontroller unit 60 is able to subtract the noise sensing signals from the sensing signals to reduce the noise. The microcontroller unit 60 is electronically connecting to the driving electrodes wires 26, the sensing electrode wires 36, and the noise sensing electrode wires 46 through flexible printed circuit.

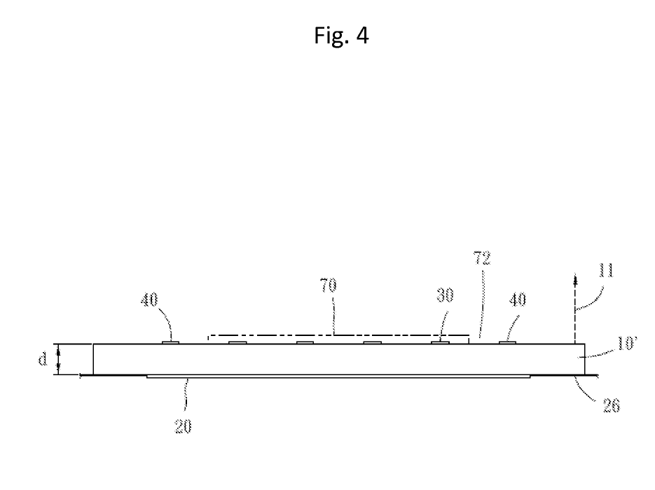

The structure of the current invention is not limited to what disclosed above, for instance, the main body 10 is not limited to comprise a top board and a bottom board. FIG. 4 is a cross sectional view of a touch control panel of the second preferred embodiment of the invention. A main body 10′ comprises a top surface and a bottom surface. The driving electrodes 20 and the driving electrodes wires 26 disposed on the bottom surface of the main body 10′. The sensing electrodes 30 and the sensing electrode wires 36 (not shown in FIG. 4) disposed on the top surface of the main body 10′. The noise sensing electrodes 40 and the noise sensing electrode wires 46 (not shown in FIG. 4) disposed on the top surface of the main body 10′. The driving electrodes 20, driving electrodes wires 26, sensing electrodes 30, sensing electrode wires 36, noise sensing electrodes 40, and noise sensing electrode wires 46 are perpendicular to the normal line 11. The extending direction of the sensing electrodes 30 is perpendicular to the extending direction of the driving electrodes 20. distance between the driving electrodes 20 and the sensing electrodes 30 is the thickness d of the main body 10′, in this case, capacitive coupling can be occurred between the driving electrodes 20 and the sensing electrodes 30. The intersection area of the driving electrodes 20 and the sensing electrodes 30 is covered by the sensing area 70. The noise sensing electrodes 40 are located in the non-sensing area 72, and the two noise sensing electrodes 40 are disposed on the left and right side of the sensing electrodes 30. The distance between the driving electrodes 20 and the noise sensing electrodes 40 is the thickness d of the main body 10′; in this case, capacitive coupling can be occurred between the driving electrodes 20 and the noise sensing electrodes 40. Each noise sensing electrode 40 electronically connected to one of the noise sensing electrode wires 46.

In the second preferred embodiment of the invention, the driving electrodes 20 and the driving electrodes wires 26 can disposed on the top surface of the main body 10′. The sensing electrodes 30 and the sensing electrode wires 36 (not shown in FIG. 4) can disposed on the bottom surface of the main body 10′. The noise sensing electrodes 40 and the noise sensing electrode wires 46 (not shown in FIG. 4) disposed on the bottom surface of the main body 10′. Besides, the noise sensing electrodes 40 can also disposed on the same surface as the driving electrodes 20 but a distance is required in order to form a capacitive coupling.

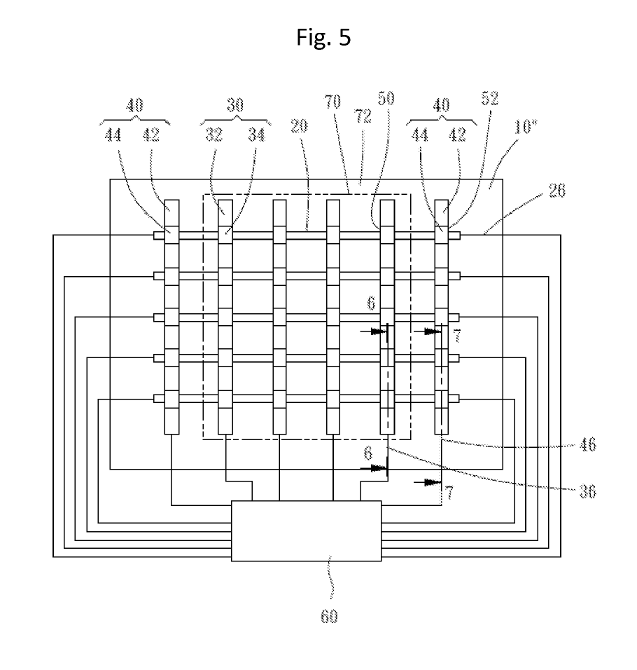

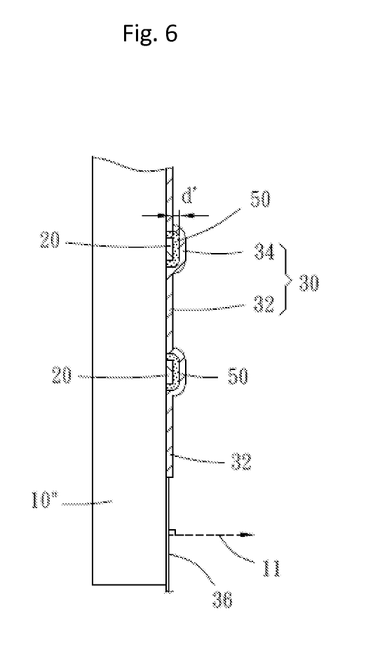

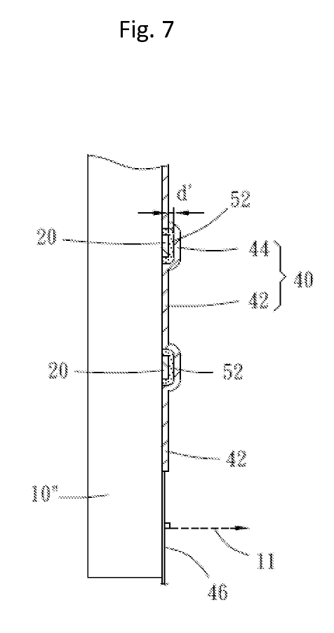

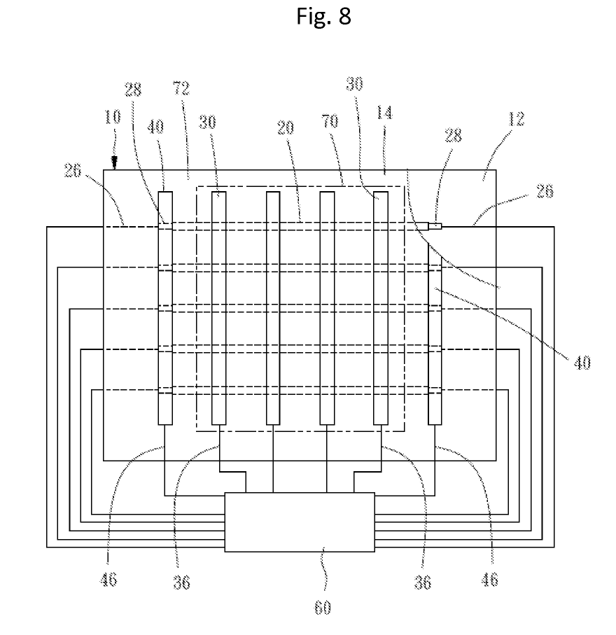

The driving electrodes 20 and the sensing electrodes 30 are not limited to dispose on different surface of the main body 10′. FIG. 5-7 show a touch control panel of the third preferred embodiment of the invention. A main body 10″ comprises a top surface. The driving electrodes 20, driving electrodes wires 26, sensing electrode wires 36, and noise sensing electrode wires 46 disposed on the top surface of the main body 10″. The extending direction of the sensing electrodes 30 is perpendicular to the extending direction of the driving electrodes 20. A plurality first isolation layer 50 covers the driving electrodes 20 in the crossing points of the sensing electrodes 30 and the driving electrodes 20. As shown in FIG. 6, the sensing electrodes 30 comprise a plurality of bridging segments 34 and a plurality of flat segments 32. The flat segments 32 disposed on the top surface of the main body 10 and located on each side of the each driving electrodes 20. The bridging segments 34 disposed on the top surface of the first isolation layer 50 and located above the driving electrodes 20. The intersection area of the bridging segments 34 and the driving electrodes 20 is covered by the sensing area 70. Capacitive coupling can be occurred between the driving electrodes 20 and the bridging segments 34 because there is a distance, which is the thickness d′ of the first isolation layer 50 between them. A plurality second isolation layer 52 covers the driving electrodes 20 in the crossing points of the noise sensing electrodes 40 and the driving electrodes 20. The noise sensing electrodes 40 comprise a plurality of bridging segments 44 and a plurality of flat segments 42. The flat segments 42 disposed on the top surface of the main body 10 and located on each side of the each driving electrodes 20. The bridging segments 44 disposed on the top surface of the second isolation layer 52 and located above the driving electrodes 20. As shown in FIG. 7, each bridging segment 44 is connected with two flat segments 42. Capacitive coupling can be occurred between the driving electrodes 20 and the bridging segments 44 because there is a distance, which is the thickness d′ of the second isolation layer 52 between them. In the third preferred embodiment of the invention, as shown in FIG. 8, all the electrodes and the wires disposed on the bottom surface of the main body.

In the forth preferred embodiment, as shown in FIG. 8, every driving electrodes wire 26 comprises a wire end 28, which electronically connected with the driving electrodes 20. Wire width of the wire end 28 is greater than other part of the driving electrodes wires. The noise sensing electrodes 40 are perpendicular to the normal line 11. The extending direction of the noise sensing electrodes 40 is perpendicular to the extending direction of the driving electrodes wires 26. There is a predesigned distance between the noise sensing electrodes 40 and the driving electrodes wires 26 so that a capacitive coupling can occur. More particular, the noise sensing electrodes 40 and the driving electrodes wires 26 intersect at the wire end 28. The distance between the wire end 28 of the driving electrodes wires 26 and the noise sensing electrodes 40 is the thickness d of the top board 14; in this case, capacitive coupling can be occurred between the driving electrodes wires 26 and the noise sensing electrodes 40. The right top corner of FIG. 8 shows the driving electrodes wire 26 and the wire end 28, which disposed on the top surface of the bottom board 12. In the forth preferred embodiment, if the wire ends 28 have the same width as other part of the driving electrodes wires 26, the capacitive coupling can still occurred. The strength of capacitive coupling will be weaken.

In the second preferred embodiment, the capacitive coupling can occur between the wire end 28 of the driving electrodes wires 26 and the noise sensing electrodes 40 as well due to the thickness of the main body between the driving electrodes wires 26 and the noise sensing electrodes 40. In the third preferred embodiment, the capacitive coupling can occur between the wire end 28 of the driving electrodes wires 26 and the noise sensing electrodes 40 as well. In this case, the second isolation layer 52 covers the end of the driving electrodes 20. The bridging segments 44 of the noise sensing electrodes 40 disposed on the top surface of the second isolation layer 52 and located above the wire end 28 of the driving electrodes wires 26. Capacitive coupling can be occurred between the wire end 28 and the bridging segments 44 because there is a distance, which is the thickness of the second isolation layer 52 between them.

In order to increase the signal intensity, the two ends of the sensing electrodes 30 electronically connect with two sensing electrode wires 36. The two ends of the noise sensing electrodes 40 can electronically connect with the noise sensing electrode wires 46 as well.

The electrodes located within the sensing area 70 including part or all of the driving electrodes 20 and the sensing electrodes 30 are made of transparent conductive materials like indium tin oxide (ITO). The electrodes located within the non-sensing area 72 including rest parts of the driving electrodes 20 and part of the noise sensing electrodes 40 do not need transparent. The electrodes located within the non-sensing area 72 can be made of indium tin oxide (ITO), silver paste film, or other conductive materials based on demand.

In the previous description and figures, there are two noise sensing electrodes 40 perpendicular to the normal line 11 and intersect with the two ends of the driving electrodes 20 or intersect with both sides of the driving electrode wires 26. Only one noise sensing electrode 40 intersect with the one end of the driving electrodes 20 or intersect with one side of the driving electrode wires 26 can achieve the same function, but the effectiveness of noise reduction is not that good. Besides, the noise sensing electrodes 40 are not limited to intersect with all driving electrode wires 26. The noise sensing electrodes 40 are not limited to intersect with all driving electrodes 20. The noise sensing electrodes 40 can intersect with part of the driving electrodes 20 or part of the driving electrode wires 26. The noise sensing electrodes 40 are not limited to the location described before. The noise sensing electrodes 40 can be disposed on any location as long as noise sensing electrodes 40 perpendicular to the normal line 11, intersect with the two ends of the driving electrodes 20 or intersect with both sides of the driving electrode wires 26, and the intersection points located inside the non-sensing area 72.

The thicknesses of the driving electrodes 20, the driving electrode wires 26, the sensing electrodes 30, the sensing electrode wires 36, the noise sensing electrodes 40, the noise sensing electrode wires 46, the first isolation layer 50, and the second isolation layer 52 are examples in order to illustrate the embodiments. The real thicknesses are extremely thin. The thickness in the figures is modified to show the characteristics clearly and did not draw according to real proportion.

Each embodiment of the current invention further comprises a micro controller unit (MCU). The micro controller unit electronically connects with the driving electrode wires, the sensing electrode wires, and the noise sensing electrode wires. The micro controller unit send driving signal to the driving electrodes through the driving electrode wires. The micro controller unit receive sensing signal from the sensing electrodes through the sensing electrode wires. The micro controller unit receive noise signal from the noise sensing electrodes through the noise sensing electrode wires. The micro controller unit subtracts the noise signal from the sensing signal to reduce the noise.

Although the invention has been explained in relation to its preferred embodiment, it is to be understood that many other possible modifications and variations can be made without departing from the spirit and scope of the invention as herein described. For instance, the main body can be a curved board. The location of the bottom board 12 and the top board 14 is not limited to that shown in FIG. 1; the bottom board can locate below the top board 14. The driving electrodes, the sensing electrodes, and the noise sensing electrodes are not limited to the strip shape as shown in FIG. 1-8. The driving electrodes, the sensing electrodes, and the noise sensing electrodes can be any shape, like strings of diamond, as long as they can achieve the same function. The extension directions of driving electrodes, the sensing electrodes, and the noise sensing electrodes are not limited to that shown in FIG. 1-8.

What is claimed is:

1. A noise reduction capacitive touch control panel, the middle of it has a sensing area and the rest area of the panel is a non-sensing area, comprising:
a main body;
a plurality of driving electrodes;
a plurality of driving electrode wires;
a plurality of sensing electrodes;
a plurality of sensing electrode wires;
at least one noise sensing electrodes;
at least one noise sensing electrode wires;
said main body being a flat board comprising a normal line;
said driving electrodes being strip electrodes;
said driving electrodes disposed on said main body parallel to each other;
said driving electrodes being perpendicular to said normal line;
each side of said driving electrodes being electronically connected with one of said driving electrode wires;
said sensing electrodes being strip electrodes;
said sensing electrodes disposed on said main body parallel to each other;
said sensing electrodes being perpendicular to said normal line;
the extending direction of said sensing electrodes being perpendicular to the extending direction of said driving electrodes;
said sensing electrodes and said driving electrodes spaced a predetermined distance;
the intersection points of said driving electrodes and said sensing electrodes being located within said sensing area;
each side of said sensing electrodes being electronically connected with one of said sensing electrode wires;
said noise sensing electrodes being strip electrodes;
said noise sensing electrodes disposed on said main body and located in said non-sensing area;
said noise sensing electrode being perpendicular to said normal line;
said noise sensing electrode and said driving electrodes intersect and spaced a predetermined distance; and
said at least one noise sensing electrode wires electronically connect to each side of said noise sensing electrode respectively.

2. The noise reduction capacitive touch control panel, the middle of it has a sensing area and the rest area of the panel is a non-sensing area of claim 1, comprising:
said main body comprises a top board and a bottom board;
said bottom board located below said top board;
said driving electrodes and said driving electrode wires disposed on said bottom board of said main body; and
said sensing electrodes, said sensing electrode wires, said noise sensing electrodes, and said noise sensing electrode wires disposed on said top board of said main body.

3. The noise reduction capacitive touch control panel, the middle of it has a sensing area and the rest area of the panel is a non-sensing area of claim 2, comprising:
a micro controller unit (MCU);
said micro controller unit electronically connects with said driving electrode wires, said sensing electrode wires, and said noise sensing electrode wires;
said micro controller unit send driving signal to said driving electrodes through said driving electrode wires;
said micro controller unit receive sensing signal from said sensing electrodes through said sensing electrode wires;
said micro controller unit receive noise signal from said noise sensing electrodes through said noise sensing electrode wires; and
said micro controller unit subtracts said noise signal from said sensing signal to reduce the noise.

4. The noise reduction capacitive touch control panel, the middle of it has a sensing area and the rest area of the panel is a non-sensing area of claim 1, comprising:
said main body comprises a top surface and a bottom surface;
said bottom surface located below said top board;
said driving electrodes and said driving electrode wires disposed on said bottom surface of said main body; and
said sensing electrodes, said sensing electrode wires, said noise sensing electrodes, and said noise sensing electrode wires disposed on said top surface of said main body.

5. The noise reduction capacitive touch control panel, the middle of it has a sensing area and the rest area of the panel is a non-sensing area of claim 4, comprising:
a micro controller unit (MCU);
said micro controller unit electronically connects with said driving electrode wires, said sensing electrode wires, and said noise sensing electrode wires;
said micro controller unit send driving signal to said driving electrodes through said driving electrode wires;
said micro controller unit receive sensing signal from said sensing electrodes through said sensing electrode wires;
said micro controller unit receive noise signal from said noise sensing electrodes through said noise sensing electrode wires; and
said micro controller unit subtracts said noise signal from said sensing signal to reduce the noise.

6. The noise reduction capacitive touch control panel, the middle of it has a sensing area and the rest area of the panel is a non-sensing area of claim 1, comprising:
said main body comprises a top surface;
said driving electrodes, said driving electrode wires, said sensing electrode wires, and said noise sensing electrode wires disposed on said top surface of said main body;
a plurality of first isolation layer;
said first isolation layer covers the driving electrodes in the crossing points of said sensing electrodes and said driving electrodes;
a plurality second isolation layer; and
said second isolation layer covers said driving electrodes in the crossing points of said noise sensing electrodes and said driving electrodes.

7. The noise reduction capacitive touch control panel, the middle of it has a sensing area and the rest area of the panel is a non-sensing area of claim 6, comprising:
a micro controller unit (MCU);
said micro controller unit electronically connects with said driving electrode wires, said sensing electrode wires, and said noise sensing electrode wires;
said micro controller unit send driving signal to said driving electrodes through said driving electrode wires;
said micro controller unit receive sensing signal from said sensing electrodes through said sensing electrode wires;
said micro controller unit receive noise signal from said noise sensing electrodes through said noise sensing electrode wires; and
said micro controller unit subtracts said noise signal from said sensing signal to reduce the noise.

8. The noise reduction capacitive touch control panel, the middle of it has a sensing area and the rest area of the panel is a non-sensing area of claim 6, comprising:
said sensing electrodes comprise a plurality of bridging segments and a plurality of flat segments;
said flat segments disposed on said top surface of said main body and located on each side of each said driving electrodes;
said bridging segments disposed on said top surface of said first isolation layer and located above said driving electrodes;
each side of said bridging segment connect with one said flat segment;
said noise sensing electrodes comprise a plurality of bridging segments and a plurality of flat segments;
said flat segments disposed on said top surface of said main body and located on each side of each said driving electrodes;
said bridging segments disposed on said top surface of said second isolation layer and located above said driving electrodes; and
each side of said bridging segment connected with one said flat segment.

9. The noise reduction capacitive touch control panel, the middle of it has a sensing area and the rest area of the panel is a non-sensing area of claim 8, comprising:
the intersection area of said bridging segments and said driving electrodes being covered by said sensing area.

10. A noise reduction capacitive touch control panel, the middle of it has a sensing area and the rest area of the panel is a non-sensing area, comprising:
a main body;
a plurality of driving electrodes;
a plurality of driving electrode wires;
a plurality of sensing electrodes;
a plurality of sensing electrode wires;
at least one noise sensing electrodes;
every said driving electrodes wire comprises a wire end;
at least one noise sensing electrode wires;
said main body being a flat board comprising a normal line;
said driving electrodes being strip electrodes;
said driving electrodes disposed on said main body parallel to each other;
said driving electrodes being perpendicular to said normal line;
each side of said driving electrodes being electronically connected with one of said wire end of said driving electrode wires;
said sensing electrodes being strip electrodes;
said sensing electrodes disposed on said main body parallel to each other;
said sensing electrodes being perpendicular to said normal line;
the extending direction of said sensing electrodes being perpendicular to the extending direction of said driving electrodes;
said sensing electrodes and said driving electrodes spaced a predetermined distance;
the intersection points of said driving electrodes and said sensing electrodes being located within said sensing area;
each side of said sensing electrodes being electronically connected with one of said sensing electrode wires;
said noise sensing electrodes being strip electrodes;
said noise sensing electrodes disposed on said main body and located in said non-sensing area;
said noise sensing electrode being perpendicular to said normal line;
said noise sensing electrode and said driving electrodes intersect and spaced a predetermined distance; and
said at least two noise sensing electrode wires electronically connect to each side of said noise sensing electrode respectively.

11. The noise reduction capacitive touch control panel, the middle of it has a sensing area and the rest area of the panel is a non-sensing area of claim 10, comprising:
said main body comprises a top board and a bottom board;
said bottom board located below said top board;
said driving electrodes and said driving electrode wires disposed on said bottom board of said main body; and
said sensing electrodes, said sensing electrode wires, said noise sensing electrodes, and said noise sensing electrode wires disposed on said top board of said main body.

12. The noise reduction capacitive touch control panel, the middle of it has a sensing area and the rest area of the panel is a non-sensing area of claim 11, comprising:
a micro controller unit (MCU);
said micro controller unit electronically connects with said driving electrode wires, said sensing electrode wires, and said noise sensing electrode wires;
said micro controller unit send driving signal to said driving electrodes through said driving electrode wires;
said micro controller unit receive sensing signal from said sensing electrodes through said sensing electrode wires;
said micro controller unit receive noise signal from said noise sensing electrodes through said noise sensing electrode wires; and
said micro controller unit subtracts said noise signal from said sensing signal to reduce the noise.

13. The noise reduction capacitive touch control panel, the middle of it has a sensing area and the rest area of the panel is a non-sensing area of claim 10, comprising:
said main body comprises a top surface and a bottom surface;
said bottom surface located below said top board;
said driving electrodes and said driving electrode wires disposed on said bottom surface of said main body; and
said sensing electrodes, said sensing electrode wires, said noise sensing electrodes, and said noise sensing electrode wires disposed on said top surface of said main body.

14. The noise reduction capacitive touch control panel, the middle of it has a sensing area and the rest area of the panel is a non-sensing area of claim 13, comprising:
a micro controller unit (MCU);
said micro controller unit electronically connects with said driving electrode wires, said sensing electrode wires, and said noise sensing electrode wires;
said micro controller unit send driving signal to said driving electrodes through said driving electrode wires;
said micro controller unit receive sensing signal from said sensing electrodes through said sensing electrode wires;
said micro controller unit receive noise signal from said noise sensing electrodes through said noise sensing electrode wires; and
said micro controller unit subtracts said noise signal from said sensing signal to reduce the noise.

15. The noise reduction capacitive touch control panel, the middle of it has a sensing area and the rest area of the panel is a non-sensing area of claim 10, comprising:
said main body comprises a top surface;
said driving electrodes, said driving electrode wires, said sensing electrode wires, and said noise sensing electrode wires disposed on said top surface of said main body;
a plurality of first isolation layer;
said first isolation layer covers the driving electrodes in the crossing points of said sensing electrodes and said driving electrodes;
a plurality second isolation layer; and
said second isolation layer covers said driving electrodes in the crossing points of said noise sensing electrodes and said driving electrodes.

16. The noise reduction capacitive touch control panel, the middle of it has a sensing area and the rest area of the panel is a non-sensing area of claim 15, comprising:
a micro controller unit (MCU);
said micro controller unit electronically connects with said driving electrode wires, said sensing electrode wires, and said noise sensing electrode wires;
said micro controller unit send driving signal to said driving electrodes through said driving electrode wires;
said micro controller unit receive sensing signal from said sensing electrodes through said sensing electrode wires;
said micro controller unit receive noise signal from said noise sensing electrodes through said noise sensing electrode wires; and
said micro controller unit subtracts said noise signal from said sensing signal to reduce the noise.

17. The noise reduction capacitive touch control panel, the middle of it has a sensing area and the rest area of the panel is a non-sensing area of claim 15, comprising:
said sensing electrodes comprise a plurality of bridging segments and a plurality of flat segments;
said flat segments disposed on said top surface of said main body and located on each side of each said driving electrodes;
said bridging segments disposed on said top surface of said first isolation layer and located above said driving electrodes;
each side of said bridging segment connect with one said flat segment;
said noise sensing electrodes comprise a plurality of bridging segments and a plurality of flat segments;
said flat segments disposed on said top surface of said main body and located on each side of each said driving electrodes;
said bridging segments disposed on said top surface of said second isolation layer and located above said driving electrodes;
each side of said bridging segment connected with one said flat segment; and
the intersection area of said bridging segments and said driving electrodes being covered by said sensing area.

18. The noise reduction capacitive touch control panel, the middle of it has a sensing area and the rest area of the panel is a non-sensing area of claim 10, comprising:
wire width of said wire end being greater than other part of said driving electrode wires.
